(19) United States
(12) Patent Application Publication
(10) Pub. No.: US 2013/0058078 A1
(43) Pub. Date: Mar. 7, 2013

(54) LED UNIT LAMP

(71) Applicant: Zhong Meng, Zhuhai (CN)

(72) Inventor: Zhong Meng, Zhuhai (CN)

(21) Appl. No.: 13/697,013

(22) PCT Filed: Jul. 8, 2010
(86) PCT No.: PCT/CN2010/075048

§ 371 Date: Nov. 9, 2012

(30) Foreign Application Priority Data
May 10, 2010 (CN) 2010201971827.2

(51) Int. Cl. F21L 4/04

(52) U.S. Cl. 362/191

(57) ABSTRACT

An LED unit lamp comprises a bracket, a lamp base with a LED lamp, a lampshade provided on the lamp base, and a control device. The lamp base is connected with the bracket via a movable connecting device, so as to permit the omnidirectional angular adjustment of the lamp base with respect to the bracket. A solar panel is disposed on the back side of the lamp base. A battery and a charge and discharge control device are provided in the lamp base. The solar panel is connected with the charge and discharge control device, the battery and the LED lamp via circuits.

### FIELD OF THE INVENTION

The present invention relates to LED lamps, particularly to an LED unit lamp with a hybrid PV/wind power and an automatic control device.

### BACKGROUND OF THE INVENTION

The applicant applies a Chinese utility model patent application on Apr. 10, 2009. The application name is LED unit lamp with single or multiple LED units, and the application number is 200920054251.2.

The LED unit lamp related to the said patent comprises a transparent waterproof light lampshade, an aluminous base with multiple LED units disposed on a first side thereon, an adjusting circuit for power supply, and a bottom cover of heat dispersion.

A second side of the aluminous base is opposing to the first side, and the second side contacts the bottom cover. The adjusting circuit is disposed in an inner space enclosed by the light lampshade and the bottom cover, and outlet lines are disposed in the inner space.

The LED unit lamp has a simple structure for easy to assemble, and lighting levels will meet requirement after simple assembly. However, it is not necessary to design additional heat dispersion structure, and the LED unit lamp may be used as a street light, a tunnel light, a square light, and so on.

### SUMMARY OF THE INVENTION

The present invention provides an LED unit lamp with a hybrid PV/wind power and an automatic control device.

The LED unit lamp comprises a bracket, a lamp base with an LED unit, a lampshade provided on the lamp base and a control device, wherein the lamp base is connected with the bracket via a movable connecting device, so as to permit the omnidirectional angular adjustment of the lamp base with respect to the bracket.

A solar panel is disposed on the back side of the lamp base. A battery and a charge and discharge control device are disposed in the lamp base, and the solar panel is connected with the charge and discharge control device, the battery, and the LED unit via circuits.

As preferred, the lamp base comprises an LED unit base and a battery base, wherein the LED unit is mounted on the LED unit base, and the LED unit base is connected with the battery base via one movable connecting device, while the battery base is connected with the bracket via the other movable connecting device.

As preferred, the infrared sensor is inside the lamp base.

As preferred, the control device comprises a battery temperature control unit, and the battery temperature control unit comprises a microcontroller, a temperature sensor, and a charging control switch, and the temperature sensor is connected with the battery.

As preferred, a heating device is disposed in the lamp base, being connected with the battery temperature control unit and the battery.

As preferred, a wind generator is disposed on the lamp base and/or the bracket, being electrical connected with the battery via the charge and discharge control device.

Referring to the prior art, the automatic control device and hybrid PV/wind power supplied device are added to the traditional LED unit lamp.

Every module and function is independent and displaced in the limited space. The battery, the charge and discharge control device, and the infrared sensor are focused together, that height of the frame of the solar panel is enough for the above parts, and the LED unit lamp is incorporate design, therefore, the structure is simple and it maybe reduce the installation cost and easy to maintain.

The lamp base is connected with the bracket via the movable connecting device, so as to permit the omnidirectional angular adjustment of the lamp base with respect to the bracket, which solutes the lighting and absorption of light effectively.

The automatic control device with MCU and hybrid PV/wind power supplied device increases energy efficiency, and also the service life of the LED unit lamp is longer.

### BRIEF DESCRIPTION OF THE DRAWINGS

FIG. 1 is a schematic view of the LED unit lamp of the present invention;

FIG. 2 is an exploded perspective view of the LED unit lamp of the present invention;

FIG. 3 is a schematic view of the LED unit lamp of the present invention with a wind generator.

### DETAILED DESCRIPTION OF THE PREFERRED EMBODIMENTS

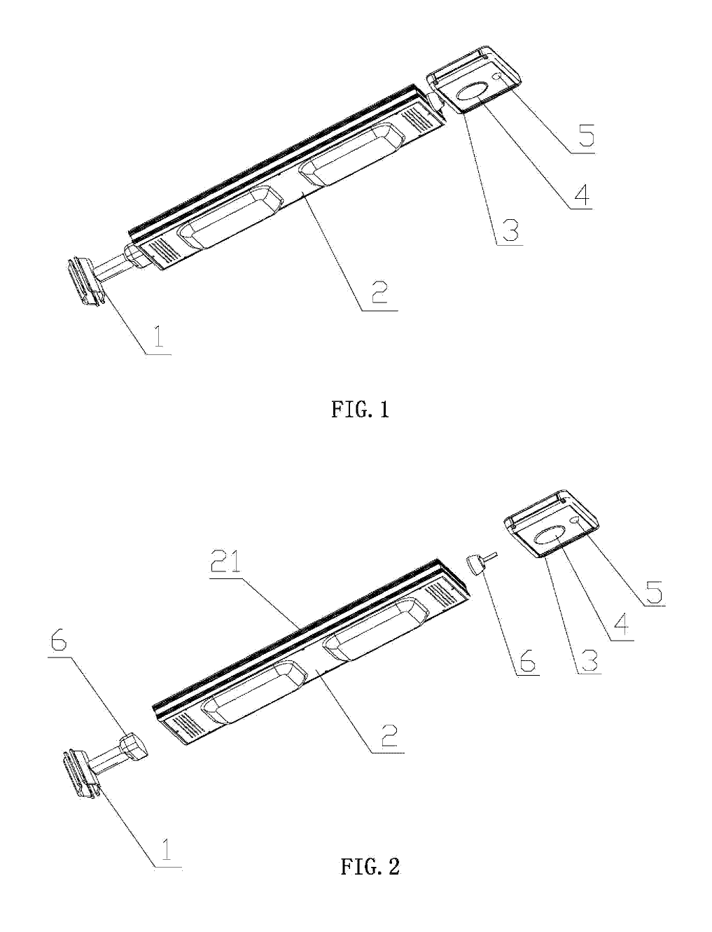

FIG. 1 and FIG. 2 show an embodiment of the present invention, and the LED unit lamp includes a bracket 1, a lamp base 2, and a control device. The lamp base 2 includes a battery base and an LED unit base 3. A battery is disposed in the battery base. A lampshade and an LED unit 4 are disposed on the LED unit base 3. The LED unit base 3 is connected with the battery base by one movable connecting device and the battery base is connected with the bracket 1 by the other movable connecting device. An infrared sensor 5 is disposed inside the LED unit base 3.

The movable connecting device of the prevent embodiment is an universal joint, which permits the omnidirectional angular adjustment of the LED unit base 3 with respect to the bracket 1, and permits the omnidirectional angular adjustment of the LED unit base 3 with respect to the battery base or the bracket 1. The control device includes a battery temperature control unit, and the battery temperature control unit includes a microcontroller, a temperature sensor, and a charging control switch. The temperature sensor is connected with the battery.

A solar panel 21 is disposed on the back side of the battery base. A charge and discharge control device is disposed in the battery base, and the solar panel 21 is connected with the charge and discharge control device, the battery, the LED unit 4, and the infrared sensor 5 via circuits.

Furthermore, a heating device is disposed inside the battery base, and the heating device is related to the battery temperature control unit and related to the battery.

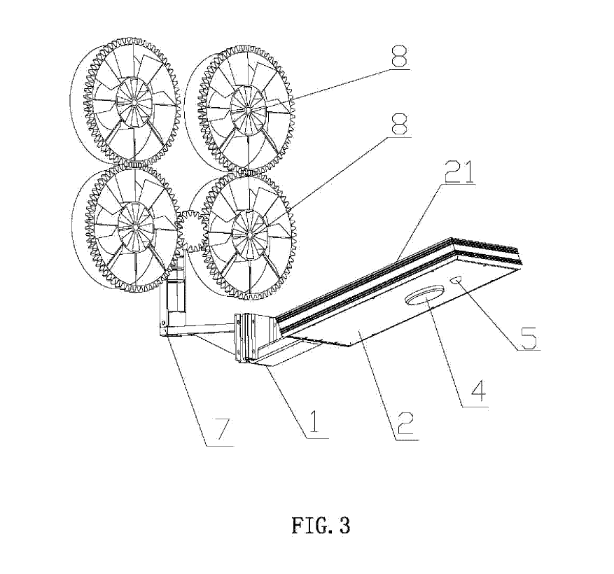

FIG. 3 shows an embodiment of the present invention, and the LED unit lamp includes a bracket 1, a lamp base 2, and a control device. An LED unit 4 is disposed in the lamp base 2, and a lampshade is provided on the LED unit 4. The lamp base 2 is connected with the bracket 1. An infrared sensor 5 is disposed on the lamp base 2.

A solar panel 21 is disposed on the back side of the lamp base 2. A charge and discharge control device is disposed in the lamp base 2, and the solar panel 21 is connected with the charge and discharge control device, the battery, an LED unit 4, and the infrared sensor 5 via circuits.

Furthermore, a heating device is disposed inside the lamp base 2, and the heating device is related to the battery temperature control unit and related to the battery.

A Four-wheel wind generator 8 is disposed on the bracket 1 by a fixed holder 7, and the Four-wheel wind generator 8 is connected with a charging control switch and the battery by the regular circuit.

The control device adopts a microcontroller (MCU) as a control core, and the temperature sensor with high accuracy (up to 1° C.) measures the surface temperature of the battery, then the temperature value is transformed to electric signals of output by analog-to-digital (A/D) conversion. The movement of the charging switch is decided by the electric signals, once the surface temperature of the battery has achieved a predetermined temperature, the solar panel and/or the wind generator will supply power to the battery.

In contrast, once the surface temperature of the battery has been below the predetermined temperature, the charging switch would prevent the solar panel and/or the wind generator from supplying power to the battery. Meantime, the heating device would begin to heat the battery until up to the predetermined temperature, then the solar panel and/or the wind generator would start to supply power to battery by the switch matrix. Therefore, the battery is protected.

The present invention of the LED unit lamp is supplied with hybrid PV/wind power, specially related to the Four-wheel wind generators. The wind generator has advantages of low cut-in wind speed, high generating efficiency, as well as strong adaptability. The wind generator is not necessary to stop even if the wind speed is very high, the power maybe output directly and the generator will not be broken. The power generated by the high wind speed would be very useful for the battery, and the LED unit will achieve sufficient power.

What is claimed is:

1. An LED unit lamp comprising:
a bracket;
a lamp base with an LED unit;
a lampshade, provided on the lamp base;
a control device;
a solar panel, being disposed on the back side of the lampe base;
a battery, being disposed in the lamp base; and
a charge and discharge control device, being disposed in the lamp base;
wherein the lamp base is connected with the bracket via a movable connecting device to permit the omnidirecitonal angular adjustment of the lamp base with respect to the bracket; the solar panel is connected with the charge and discharge control device, the battery, and the LED unit via circuits.

2. The LED unit lamp as set forth in claim 1, the lamp base comprising an LED unit base and a battery base, wherein the LED unit is mounted on the LED unit base, and the LED unit base is connected with the battery base by one said movable connecting device, while the battery base is connected with the bracket by the other movable connecting device.

3. The LED unit lamp as set forth in claim 1, further comprising an infrared sensor being disposed in the LED lamp.

4. The LED unit lamp as set forth in claim 1, the control device comprising a battery temperature control unit, and the battery temperature control unit includes a microcontroller, a temperature sensor, and a charging control switch, and the temperature sensor is connected with the battery.

5. The LED unit lamp as set forth in claim 1, further comprising a heating device being disposed in the lamp base, wherein the heating device is connected with the battery temperature control unit and the battery.

6. The LED unit lamp as set forth in claim 1, further comprising a wind generator disposed on the lamp base or the bracket, being electrical connected with the battery via the charge and discharge control device.
